(19) United States
(12) Patent Application Publication
(10) Pub. No.: US 2024/0051228 A1
(43) Pub. Date: Feb. 15, 2024

(54) THREE-DIMENSIONAL PRINTING METHOD AND SYSTEM FOR PRINTING COMPOSITE MATERIALS

(71) Applicant: SPHERECUBE S.R.L., Ancona (IT)

(72) Inventors: Valerio DI POMPEO, Ancona (IT); Alessio VITA, Ancona (IT); Eleonora SANTECCHIA, Ancona (IT); Fabrizio CICIULLA, Ancona (IT)

(73) Assignee: SPHERECUBE S.R.L., Ancona (IT)

(21) Appl. No.: 18/551,464

(22) PCT Filed: Mar. 15, 2022
(86) PCT No.: PCT/IB2022/052324

§ 371 Date: Sep. 20, 2023

(30) Foreign Application Priority Data
Mar. 22, 2021 (IT) 102021000006800

(51) Int. Cl. B29C 64/295; B29C 64/118; B29C 64/209; B29C 64/268; B29C 64/314; B33Y 10/00; B33Y 40/10; B33Y 40/20; B29C 35/02; B33Y 70/10

(52) U.S. Cl. CPC B29C 64/295; B29C 64/118; B29C 64/209; B29C 64/268; B29C 64/314; B33Y 10/00; B33Y 40/10; B33Y 40/20; B29C 35/0272; B33Y 70/10; B29C 2035/0811

(57) ABSTRACT

A three-dimensional printing method of composite materials comprises at least the following phases: supply of one three-dimensional printing device; supply of one thermosetting resin and of one filament comprising one fiber; feeding of the thermosetting resin and of the filament inside the three-dimensional printing device; impregnation of the filament in the thermosetting resin to obtain a composite material wherein the filament is wrapped by the thermosetting resin; extrusion of the composite material onto a work surface to form one layer; heating of the composite material to induce a cure of the thermosetting resin; wherein the heating phase comprises a step of direct heating of the filament and a step of indirect heating of the thermosetting resin by heat conduction from the filament.

### TECHNICAL FIELD

The present invention relates to a three-dimensional printing method and system of composite materials.

### BACKGROUND ART

In the field of additive manufacturing, it can be appreciated how small the known methods and systems for additive printing of composites with polymer matrix with long fiber reinforcement are.

Polymer matrices generally used in such applications are distinguished between thermoplastic and thermosetting matrices.

It should be noted that there are even fewer known additive printing methods and systems that take advantage of long fiber reinforcements and thermosetting matrices.

Thermosetting matrices are used in about 70% of known production processes, as they give the best possible mechanical properties to finished products.

The methods exploiting the use of thermosetting matrices provide for a distribution on a work surface of the matrix itself, which is then subjected to a solidification process.

In particular, depending on the type of thermosetting matrix used, solidification can be carried out e.g. by means of the use of UV radiation or by supplying heat.

On the other hand, known 3D printing methods are based on the extrusion of thermoplastic matrices, which have very limited performance compared to thermosetting matrices.

The deposition mode for reinforced thermoplastic matrices is based on the liquefaction of the thermoplastic material with subsequent solidification.

This process generally results in the formation of “voids”, i.e. cavities or holes, which reduce the physical and mechanical strength of the finished product. The presence of these voids is due to the inability of the thermoplastic material to efficiently cover the surface of the reinforcing fiber, thus eliminating the air bubbles. A percentage of voids around even only 2-3% determine a strong impact on the mechanical characteristics, thus reducing the mechanical strength up to 35%.

As far as the reinforcing fiber is concerned, on the other hand, in the field of additive manufacturing, short fibers are generally used in low quantities, which aim to improve the aesthetic quality rather than the mechanical, chemical and thermal performance of the products.

At the same time, the known three-dimensional printing systems are extremely constrained, since the user has no possibility to intervene on the process parameters. This causes the impossibility to change the amount of resin present in the product made of composite material during the process and the impossibility to change the type of the reinforcement fiber. Therefore, with these systems only components with the same characteristics can be made, thus strongly limiting the intrinsic versatility of the composite material.

It is evident, therefore, that there is a need to upgrade the known three-dimensional printing methods and systems of composite materials.

### DESCRIPTION OF THE INVENTION

The main aim of the present invention is to devise a three-dimensional printing method and system of composite materials which allow high-performance, large-sized products made of composite material to be manufactured by means of a single manufacturing process thus ensuring high flexibility in the design thereof.

Another object of the present invention is to devise a three-dimensional printing method and system of composite materials which allow high production versatility and enable easy intervention on the process parameters.

A further object of the present invention is to devise a three-dimensional printing method and system of composite materials which are compact in size and easy to use.

Another object of the present invention is to devise a three-dimensional printing method and system of composite materials which allow overcoming the aforementioned drawbacks of the prior art within the scope of a simple, rational, easy and effective to use as well as affordable solution.

The aforementioned objects are achieved by the present three-dimensional printing method of composite materials having the characteristics of claim 1.

The aforementioned objects are also achieved by the present three-dimensional printing system of composite materials having the characteristics of claim 13.

### BRIEF DESCRIPTION OF THE DRAWINGS

Other characteristics and advantages of the present invention will become more apparent from the description of a preferred, but not exclusive, embodiment of a three-dimensional printing method and system of composite materials, illustrated by way of an indicative, yet non-limiting example, in the accompanying tables of drawings wherein:

FIG. 1 is a view of the three-dimensional printing system according to the invention, according to a first embodiment;

FIG. 2 is a view of the three-dimensional printing system according to the invention, according to a second embodiment;

FIG. 3 is a view of the three-dimensional printing system according to the invention, according to a third embodiment.

### EMBODIMENTS OF THE INVENTION

With particular reference to these figures, reference numeral 1 globally indicates a three-dimensional printing system of composite materials.

In the context of the present disclosure, the term “composite material” means a product composed of two or more different types of material, e.g., plastic/glass, plastic/metal or the like, in which the combination of these materials gives the finished product special physical and mechanical properties.

The system 1 comprises at least one three-dimensional printing device 2 provided with at least one feeding assembly 3 of at least one thermosetting resin 4 and at least one feeding channel 5 of at least one filament 6 comprising at least one fiber.

The thermosetting resin 4 is selected from the list comprising: epoxy resin, vinylester resin, polyester resin, phenolic resin, polyurethane, polyphenol, polycyclopentadiene, polyimide.

The feeding assembly 3 comprises a pumping system communicating with a tank 7 containing the thermosetting resin 4.

The filament 6 can be made in the form of “yarn”, i.e. a set of fibers held together by a twist to form a thread, or in the form of “tow”, i.e. an untwisted bundle of continuous filaments.

The fiber is selected from: carbon fiber, aramid fiber, glass fiber, polymer fiber, boron fiber, basalt fiber, optical fiber, metallic fiber, ceramic fiber, fiber of natural plant origin such as, e.g., flax fiber, hemp fiber, etc.

Advantageously, the filament 6 is of the continuous type.

The filament 6 may, e.g., be wrapped onto a spool and introduced into the three-dimensional printing device 2 through the feeding channel 5 by means of a movement unit 8.

The movement unit 8 may comprise, e.g., a system of rollers or belts adapted to make the filament 6 slide.

The three-dimensional printing device 2 also comprises at least one extrusion channel 9 communicating with the feeding assembly 3 and with the feeding channel 5 adapted to receive the thermosetting resin 4 and the filament 6 to form a composite material 10.

In more detail, the composite material 10 comprises the filament 6 wrapped by the thermosetting resin 4.

In the extrusion channel 9, the filament 6 is impregnated in the thermosetting resin 4 and is completely wrapped by the latter.

Conveniently, the filament 6 may comprise a fiber-bound binding compound which increases the wettability of the filament itself in the thermosetting resin 4 and promotes impregnation and flow thereof by the movement unit 8.

The extrusion channel 9 is adapted to distribute the composite material 10 on a work surface S to obtain at least one layer 11.

The three-dimensional printing system 1 also comprises movement means, not shown in detail in the figures, adapted to move the three-dimensional printing device 2 with respect to the work surface S.

More in detail, the movement means are adapted to position the three-dimensional printing device 2 in the three dimensions in an extremely precise and accurate manner.

Again, the three-dimensional printing system 1 may comprise compaction means 22 adapted to compact the layers 11 deposited by the three-dimensional printing device 2.

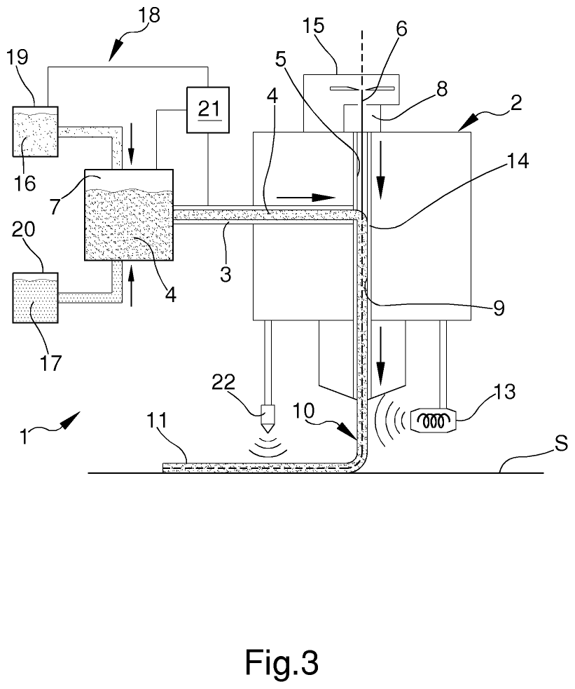

In the embodiment shown in FIG. 3, the compaction means 22 comprise a sonotrode. It cannot however be ruled out that the compaction means 22 comprise rollers, pressers or the like.

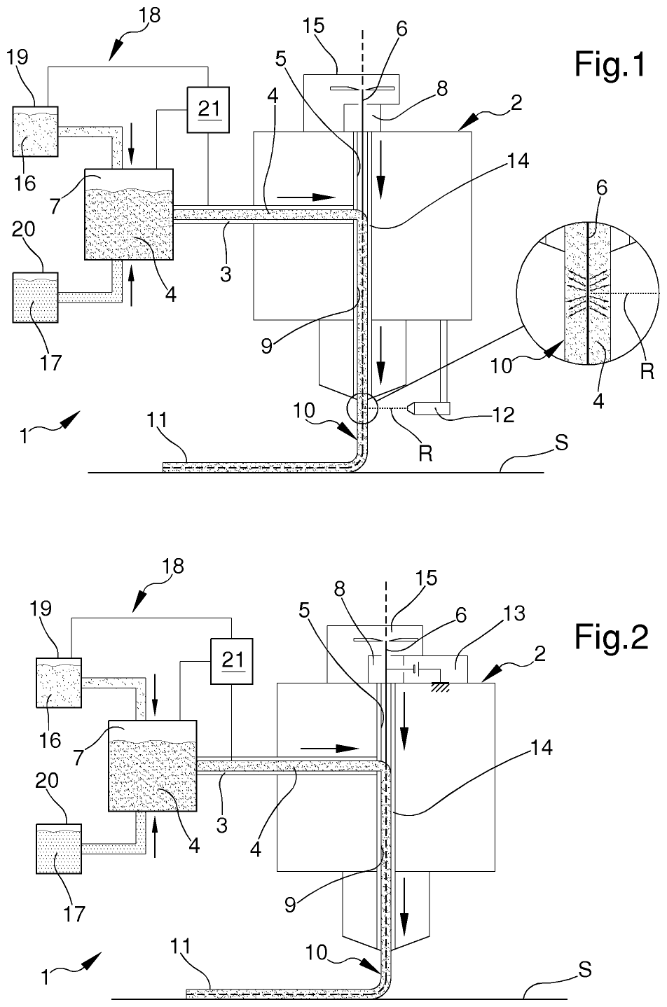

The compaction means 22 are shown in FIG. 3, however, it is easy to appreciate that the compaction means 22 may also be present in the system 1 according to the embodiments shown in FIGS. 1 and 2.

The three-dimensional printing system 1 also comprises heating means associated with the three-dimensional printing device 2 and adapted to induce a cure of the thermosetting resin 4.

The function of the heating means is to supply heat to the composite material so as to induce cross-linking of the components of the thermosetting resin 4 and subsequent curing thereof.

The heating of the thermosetting resin 4 represents an extremely delicate phase in the printing process of the composite material 10 as it is necessary to establish an intimate union between the filament 6 and the thermosetting resin itself and, at the same time, that the cross-linking of the resin occurs in an optimal manner so as to give the finished product the desired physical and mechanical properties.

According to the invention, the heating means comprise direct heating means 12, 13 of the filament 6 adapted to directly heat the filament 6 and to indirectly heat the thermosetting resin 4 by conduction of heat from the filament 6.

The direct heating means, therefore, allow the composite material 10 to be heated from within, making the cross-linking of the thermosetting resin 4 homogeneous and stable.

According to a possible embodiment shown in FIG. 1, the direct heating means 12, 13 comprise at least one radiation emitting device 12 adapted to emit radiation R towards the composite material 10.

Such an embodiment requires the thermosetting resin 4 to be permeable to radiation R.

The radiation R, therefore, directly hits the filament 6, by heating it, and consequently causes indirect heating of the thermosetting resin 4.

Specifically, the emitting device 12 is selected from either a laser device or a microwave device.

The radiation R comprises a laser beam and microwave radiation, respectively. It cannot, however, be ruled out that the emitting device 12 be of a different type.

In combination or alternatively, the direct heating means 12, 13 comprise at least one electrical current generating device 13 adapted to supply electrical energy to the filament 6.

Such an embodiment requires that the filament 6 be made of at least one electrically conductive material.

Thus, the filament 6 acts as an electrical resistor, is overheated by the flow of current and transmits heat to the thermosetting resin 4.

The electrical current generating device 13 is selected from either an electrical circuit or an induction device.

In particular, according to a possible embodiment shown in FIG. 2, the electrical current generating device 13 is an electrical circuit connected to the filament 6.

In this case, the electrical current generating device 13 is directly connected to the filament 6 and thus allows the transfer of electrical current thereto.

FIG. 3 shows a further possible embodiment wherein the electrical current generating device 13 is an induction device and allows heating the filament by electromagnetic induction.

It cannot be ruled out that the heating means may comprise both of the electrical current generating devices 13 described above.

Likewise, it cannot be ruled out that the direct heating means 12, 13 may comprise both an emitting device 12 and an electrical current generating device 13.

Advantageously, the three-dimensional printing device 2 comprises preheating means 14 of at least the thermosetting resin 4 adapted to induce at least a partial cure of the thermosetting resin 4.

The preheating means 14 are adapted to heat at least the thermosetting resin 4 prior to extrusion, so as to begin the process of cross-linking of the same.

Usefully, the preheating means 14 are associated with at least the extrusion channel 9. The preheating means 14 may comprise, e.g., a micro-tubular heating device.

The preheating means 14 wrap around the extrusion channel 9 by heating the composite material 10 during impregnation of the filament 6 and during extrusion.

The preheating means 14 are also adapted to promote the impregnation of the filament 6 in the thermosetting resin 4.

The preheating means 14 are also associated with the feeding channel 5 and are adapted to heat the filament 6 prior to impregnation.

This will result in additional heat transfer from the filament 6 to the thermosetting resin 4 upon impregnation.

Conveniently, the preheating phase is carried out at a temperature comprised between 120° C. and 200° C.

Conveniently, the three-dimensional printing device 2 comprises cutting means 15 of the filament 6.

The cutting means 15 have the function of cutting the filament 6 so as to interrupt the dispensing thereof at the end of the extrusion of each layer 11.

In the embodiment shown in the figures, the thermosetting resin 4 is of the type of a two-component resin.

It cannot, however, be ruled out that the thermosetting resin 4 be of the type of a one-component resin.

The thermosetting resin 4 is composed of at least one polymeric material 16 and of at least one curing compound 17 which are mixed upon use.

In addition, the thermosetting resin 4 may comprise additives, such as e.g. nanomaterials, adapted to give special mechanical, physical and thermal properties to the composite material 10.

To this end, the three-dimensional printing system 1 comprises mixing and degassing means 18 of at least one polymeric material 16 and of at least one curing compound 17 to obtain the thermosetting resin 4, connected to the feeding assembly 3 in a fluid-operated manner.

The mixing and degassing means 18, therefore, allow the thermosetting resin to be prepared on the fly by adjusting the mixing parameters on the basis of the printing requirements.

Specifically, the mixing and degassing means 18 comprise the tank 7, wherein the mixing takes place, a first container 19 for the polymeric material 16 and a second container 20 for the curing compound 17 connected to the tank 7 in a fluid-operated manner.

As set forth above, the tank 7 is connected to the feeding assembly 3 in a fluid-operated manner.

Conveniently, the mixing and degassing means 18 also comprise a heating assembly 21 associated with at least the tank 7.

The mixing of the polymeric material 16 and of the curing compound 17 is, advantageously, carried out at a temperature comprised between 50° C. and 100° C. This expedient makes it possible to reduce the viscosity of the polymeric material 16 and to promote the mixing of the two components.

The heating assembly 21 is also, conveniently, associated with the first tank 7 and with the feeding assembly 3.

It should be specified that, in the case where the thermosetting resin 4 is a one-component resin, the mixing and degassing means 18 only comprise the tank 7 and the heating assembly 21.

The operation of the three-dimensional printing system of composite materials in carrying out the process according to the invention is as follows.

The method first comprises a supply of at least one three-dimensional printing device 2 and a supply of at least one thermosetting resin 4 and of at least one filament 6.

In the event of the thermosetting resin 4 being a two-component resin, before the supply phase of the thermosetting resin, the method comprises:
a supply phase of at least one polymeric material 16 and of at least one curing compound 17; and
a mixing phase of the polymeric material 16 and of the curing compound 17 to obtain the thermosetting resin 4.

The mixing phase is carried out by the mixing and degassing means 18.

The method then comprises the following phases:
feeding of the thermosetting resin 4 and of the filament 6 inside the three-dimensional printing device 2;
impregnation of the filament 6 in the thermosetting resin 4 to obtain a composite material 10;
extrusion of the composite material 10 onto a work surface S to form at least one layer 11;
heating of the composite material 10 to induce a cure of the thermosetting resin 4.

In more detail, the phase of feeding is carried out by means of the feeding assembly 3 and of the feeding channel 5, respectively.

Impregnation of the filament 6 is carried out inside the extrusion channel 9, into which the filament itself and the thermosetting resin 4 convey to form the composite material 10.

Extrusion is in turn carried out by means of the extrusion channel 9 and results in the distribution of the layer 11 of composite material 10 on the work surface S.

Following extrusion, the composite material 10 is heated by the direct heating means 12, 13 in order to induce polymerization and cross-linking of the thermosetting resin 4.

According to the invention, the heating phase comprises a step of direct heating of the filament 6 and a step of indirect heating of the thermosetting resin 4.

In more detail, the step of direct heating is carried out by the direct heating means 12, 13 while the step of indirect heating is carried out by heat conduction from the filament 6.

According to a first embodiment shown in FIG. 1, direct heating is carried out by irradiation of the composite material 10 with radiation R.

As set forth above, this embodiment provides that the thermosetting resin 4 is permeable to radiation R, which passes through the thermosetting resin itself and hits the filament 6, by heating it.

Radiation R may comprise a laser beam or microwave radiation.

FIGS. 2 and 3 show possible additional embodiments wherein direct heating is carried out by generation of electrical current along the filament 6.

In this case, the filament 6 is made of at least one electrically conductive material.

In particular, the generation of electrical current may be carried out by direct transmission of electrical current to the filament 6 and/or by electromagnetic induction.

After the extrusion phase, the method comprises a cutting phase of the filament 6.

The cutting phase is carried out by the cutting means 15.

Advantageously, before the extrusion phase, the method comprises at least one preheating phase of at least the thermosetting resin 4 to induce at least a partial cure of the thermosetting resin itself.

The preheating phase is carried out using the preheating means 14 and allows the start of the curing and cross-linking process of the thermosetting resin 4.

It has in practice been ascertained that the described invention achieves the intended objects, and in particular the fact is emphasized that the three-dimensional printing method and system according to the invention allow manufacturing high-performance products of composite material of even large dimensions, by means of a single production process and ensuring high flexibility in the design thereof.

Moreover, the present method and system allow high production versatility and allow easily intervening on the process parameters.

Finally, the three-dimensional printing system according to the invention is characterized by compact size and is easy to use.

1. A three-dimensional printing method of composite materials, comprising:
supply of at least one three-dimensional printing device;
supply of at least one thermosetting resin and of at least one filament comprising at least one fiber;
feeding of said at least one thermosetting resin and of said at least one filament inside said at least one three-dimensional printing device;
impregnation of said at least one filament in said at least one thermosetting resin to obtain a composite material wherein said at least one filament is wrapped by said at least one thermosetting resin;
extrusion of said composite material onto a work surface to form at least one layer;
heating of said composite material to induce a cure of said at least one thermosetting resin, wherein
said heating phase comprises a step of direct heating of said at least one filament and a step of indirect heating of said at least one thermosetting resin by heat conduction from said at least one filament.

2. The method according to claim 1, wherein said direct heating is carried out by irradiation of said composite material with radiation, said at least one thermosetting resin being permeable to said radiation.

3. The method according to claim 2, wherein said radiation comprises at least one of either a laser beam or microwave radiation.

4. The method according to claim 1, wherein said direct heating is carried out by generation of electrical current along said at least one filament, said at least one filament being made of at least one electrically conductive material.

5. The method according to claim 4, wherein said generation of electrical current is carried out by direct transmission of electrical current to said at least one filament and/or by electromagnetic induction.

6. The method according to claim 1, wherein said at least one fiber is selected from: carbon fiber, aramid fiber, glass fiber, polymer fiber, boron fiber, basalt fiber, optical fiber, metallic fiber, ceramic fiber, fiber of natural plant origin.

7. The method according to claim 1, wherein said at least one filament is of the continuous type.

8. The method according to claim 7, wherein, after said extrusion phase, said method further comprises a cutting phase of said at least one filament.

9. The method according to claim 1, wherein, before said extrusion, said method further comprises at least one preheating phase of at least said at least one thermosetting resin to induce at least a partial cure of the at least one thermosetting resin.

10. The method according to claim 9, wherein said preheating phase is carried out at a temperature comprised between 120° C. and 200° C.

11. The method according to claim 1, wherein, before said supply phase of the at least one thermosetting resin, the method further comprises:
a supply phase of at least one polymeric material and of at least one curing compound; and
a mixing phase of said polymeric material and of said curing compound to obtain said at least one thermosetting resin.

12. The method according to claim 11, wherein said mixing phase is carried out at a temperature comprised between 50° C. and 100° C.

13. A three-dimensional printing system of composite materials, comprising:
at least one three-dimensional printing device provided with:
at least one feeding assembly of at least one thermosetting resin;
at least one feeding channel of at least one filament comprising at least one fiber;
at least one extrusion channel communicating with said feeding assembly and with said feeding channel adapted to receive said at least one thermosetting resin and said at least one filament to form a composite material, wherein said at least one filament is wrapped by said at least one thermosetting resin and adapted to distribute said composite material on a work surface to obtain at least one layer;
heating means associated with said at least one three-dimensional printing device and adapted to induce a cure of said at least one thermosetting resin, wherein
said heating means comprise direct heating means of said at least one filament adapted to directly heat said at least one filament and to indirectly heat said at least one thermosetting resin by conduction of heat from said at least one filament.

14. The system according to claim 13, wherein said direct heating means comprise at least one radiation emitting device adapted to emit radiation towards said composite material, said at least one thermosetting resin being permeable to said radiation.

15. The system according to claim 14, wherein said at least one radiation emitting device is selected from a laser device and a microwave device.

16. The system according to claim 13, wherein said direct heating means comprise at least one electrical current generating device adapted to supply electrical energy to said at least one filament, said at least one filament being made of at least one electrically conductive material.

17. The system according to claim 16, wherein said at least one electrical current generating device is selected from either an electrical circuit connected to said at least one filament or an induction device.

18. The system according to claim 13, further comprising: preheating means of at least said at least one thermosetting resin adapted to induce at least a partial cure of said at least one thermosetting resin.

19. The system according to claim 13, further comprising: cutting means of said at least one filament.

20. The system according to claim 13, further comprising: mixing and degassing means of at least one polymeric material and of at least one curing compound to obtain said at least one thermosetting resin, connected in a fluid-operated manner to said feeding assembly.
